(19) United States
(12) Patent Application Publication
(10) Pub. No.: US 2026/0168321 A1
(43) Pub. Date: Jun. 18, 2026

(54) BLIND DRIVE DEVICE WITH DIRECTION SWITCH

(71) Applicant: STS C&B. CO., LTD., Daegu (KR)

(72) Inventors: Sangik KIM, Daegu (KR); Changsik JEON, Daegu (KR)

(21) Appl. No.: 18/717,979

(22) PCT Filed: Jan. 19, 2023
(86) PCT No.: PCT/KR2023/000899

§ 371 Date: Jun. 7, 2024

(30) Foreign Application Priority Data
Jan. 17, 2023 (KR) 10-2023-0006442

(51) Int. Cl. E06B 9/68; E06B 9/262; E06B 9/264; E06B 9/322; E06B 9/324; E06B 9/326; E06B 9/327; E06B 9/40; E06B 9/42; E06B 9/50

(52) U.S. Cl. CPC E06B 9/68; E06B 9/262; E06B 9/264; E06B 9/322; E06B 9/324; E06B 9/326; E06B 9/327; E06B 9/40; E06B 9/42; E06B 9/50; E06B 2009/2625; E06B 2009/3222; E06B 2009/3265

(57) ABSTRACT

A drive device for a roller blind is disclosed. The drive device for a roller blind includes a fixed part 10 that is fixedly disposed on a side of the drum 2; a rotating part 20 that is rotatably mounted to the fixed part 10, and configured to perform the forward or reverse rotation of the drum 2 such that the curtain fabric 1 is lowered or raised; two drive cords 30 that hangs in parallel to the rotating part 20 10 in the form of an endless loop on a lower side of the fixed part 10, and transmits a rotational force to the rotating part 20; and a manipulating part 40 that is coupled so as to cover the drive cord 30 hanging on the lower side of the fixed part 10, and rotates the drive cord 30 in the forward or reverse direction according to pulling manipulation performed by a user.

### TECHNICAL FIELD

The present invention relates to a blind drive device with a direction switch, and more particularly, to a blind drive device with a direction switch in which a manipulating part is coupled so as to cover a drive cord, thereby preventing safety accidents caused by a drive cord being wrapped around a user, while the user can intuitively grasp the rotation direction of the drive cord just by the setting position of the direction switch, and further in which the user does not need to continuously press the direction switch when pulling the drive cord, thereby reducing the manipulating fatigue by the user, and at the same time, the drive cord is formed in a chain structure to ensure durability even when used for long periods of time.

### BACKGROUND ART

Generally, a roller blind has a structure in which a curtain fabric which blocks light is wrapped on a drum, and the curtain fabric is lowered or raised according to forward/reverse rotation of the drum.

A drive device which transmits forward/reverse rotational force generated by a user to the drum is provided on one side or each of opposite sides of the roller blind.

Such a drive device is basically composed of a pulley connected to the drum so as to rotate same, and a drive cord connected to the pulley so as to receive a rotational force from a user.

Here, the drive cord connected to the pulley is made in a circular closed type of drive cord, and includes two cords hanging on the pulley in a loop type toward the lower side of the blind.

That is, when the user pulls down one drive cord, the drum is rotated forward and the curtain fabric is lowered, but when the user pulls down the other drive cord, the drum is rotated reversely and the curtain fabric is raised.

As for such a roller blind, the two cords are connected to each other in a loop type, and unless otherwise indicated, it is impossible to know which cord is responsible for forward/reverse rotation, which causes inconvenience.

Above all, there is a serious problem that the drive cord may be wrapped around a person's body due to the negligence or carelessness of a user, which may lead to a safety accident.

Meanwhile, the conventional blind drive device has the problem that the user has to press the direction change switch continuously while the forward/reverse rotation of the drive cord is performed, which causes high manipulating fatigue of a user.

Therefore, there is an urgent need to develop a blind drive device with a novel structure which allows the rotation direction of the drive cord to be easily and intuitively predicted, and can reduce the manipulation fatigue when pulling the drive cord and prevent safety accidents caused by a drive cord being wrapped around a user.

### DETAILED DESCRIPTION OF THE INVENTION

### Technical Problem

The present invention has been made keeping in mind the above problems occurring in the related art, and therefore, an object thereof is to prevent in advance safety accidents caused by a drive cord being wrapped around a user.

Another object of the present invention is to enable the user to intuitively grasp the rotation direction of the drive cord by checking the setting position of the direction switch.

Yet another object of the present invention is to reduce the manipulation fatigue of a user when pulling the drive cord.

A further object of the present invention is to increase the durability of the drive cord.

### Technical Solution

According to the present invention, there is provided a drive device for a roller blind that descends or ascends a curtain fabric 1 by rotating a drum 2 around which the curtain fabric 1 is wound in the forward or reverse direction, the drive device comprising:
a fixed part 10 that is fixedly disposed on a side of the drum 2;
a rotating part 20 that is rotatably mounted to the fixed part 10, and configured to perform the forward or reverse rotation of the drum 2 such that the curtain fabric 1 is lowered or raised;
two drive cords 30 that hangs in parallel to the rotating part 20 10 in the form of an endless loop on a lower side of the fixed part 10, and transmits a rotational force to the rotating part 20; and
a manipulating part 40 that is coupled so as to cover the drive cord 30 hanging on the lower side of the fixed part 10, and rotates the drive cord 30 in the forward or reverse direction according to pulling manipulation performed by a user.

Further, the fixed part 10 of the present invention comprises:
a fixed casing 11 that has an inner diameter capable of receiving the rotating part 20, and has a passage provided on a lower end thereof into a predetermined size such that the drive cord 30 is connected to the rotating part 20 and the manipulating part 40; and
a fixed shaft 12 that is inserted into and mounted to a center of the fixed casing 11 and rotatably supports the rotating part 20.

Further, the rotating part 20 of the present invention comprises:
a rotating wheel 21 that is rotatably mounted to the inside of the fixed case 11, and is connected to the drive cord 30 so as to receive forward/reverse direction rotational force therefrom; and
a drum holder 22 that is mounted to the rotating wheel 21 by being engaging therewith, and is configured to be inserted into a center of one side of the drum 2 to perform the forward/reverse rotation of the drum 2.

Further, the drive cord 30 of the present invention is characterized by being formed in a chain structure.

Further, the chain structure is characterized in that spherical balls 33 are coupled to a cord 31 at predetermined intervals.

Further, the manipulating part 40 of the present invention comprises:
a drive cord guide plate 41 in which a pair of guide grooves 411 opened at both ends are formed in a longitudinal direction; and
a rotating gear 43 that is rotatably coupled to one side of the lower part of the drive cord guide plate 41,
wherein the drive cord 30 is inserted into the guide groove 411 and travels, and the drive cord 30 meshes with the rotating gear 43 to change the direction of the drive cord 30.

Further, the blind drive device further comprises an upper cover 45 that is coupled so as to cover the upper part of the drive cord guide plate 41 to prevents separation of the drive cord 30; and a lower cover 47 that prevents separation of the drive cord 30.

Further, the manipulating part 40 of the present invention comprises a traction handle 49 that is slidably coupled to the drive cord guide plate 41, and rotates the drive cord 30 in the forward or reverse direction by selectively pressing any one of the two drive cords 30 arranged in parallel in the form of an endless track.

Further, the traction handle 49 of the present invention comprises:
a base plate 492 provided with a switch guide 4921 formed into a groove shape or a protruding slot shape to guide the movement of the direction switch 494, and a hinge groove 4923 into which a rotating pin 4961 of a drive cord holding part 496 is inserted;
a direction switch 494 in which a guide protrusion 4941 coupled to the switch guide 4921 is formed at the rear, and an adjustment protrusion 4943 that adjusts the direction switch 494 is formed at the front;
a drive cord holding part 496 in which a hinge pin 4961 is formed at the rear so as to be rotatable relative to the base plate 492, and a pointed edge-shaped holding protrusion 4963 for pressing the drive cord 30 are formed on both sides surface;
a spring 495 in which one end is coupled to the direction switch 494, and the other end is coupled to a portion higher than the rotating pin 496 in the drive cord holding part 496; and
a front handle cover 491 that is coupled to cover the front of the base plate 492, and a direction switch opening 4911 is formed to expose the adjustment protrusion 4943,
wherein when the adjustment protrusion 4943 moves to the left or right, the elastic force caused by the spring 495 rotates the drive cord holding part 496 around the rotating pin 4961, and moves in a direction opposite to the moving direction of the adjustment protrusion 4943 and presses the drive cord 30.

### Advantageous Effects

A blind drive device according to the present invention has the effect of preventing in advance safety accidents caused by a drive cord being wrapped around a user.

Also, the present invention has the effect of enabling the user to intuitively grasp the rotation direction of the drive cord by checking the setting position of the direction switch.

Further, the present invention has the effect of reducing the manipulation fatigue of a user when pulling the drive cord.

Further, the present invention has the effect of increasing the durability of the drive cord.

In addition to the above-described effects, specific effects of the present invention will be described while explaining specific details for carrying out the invention below.

### BRIEF DESCRIPTION OF THE DRAWINGS

FIG. 1 is a front view illustrating a roller blind to which a drive device according to the present invention is applied.

FIG. 2 is a perspective view of the drive device according to the present invention.

FIG. 3 is an exploded view of the drive device according to the present invention.

FIG. 4 is a perspective view of the drive cord and the manipulating part according to the present invention.

FIG. 5 is an exploded view of the drive cord guide plate according to the present invention.

FIG. 6 is a perspective view of the traction handle according to the present invention.

FIG. 7 is an exploded view of the traction handle according to the present invention.

FIG. 8 is an enlarged view of the direction switch and the drive cord holding part according to the present invention.

FIG. 9 is a diagram showing a state in which the drive cord holding part according to the present invention fixes the right drive cord.

FIG. 10 is a diagram showing a state in which the drive cord holding part according to the present invention fixes the left drive cord.

### DETAILED DESCRIPTION OF THE EMBODIMENTS

Hereinafter, various embodiments of the disclosure will be described with reference to the accompanying drawings. However, it should be understood that they are not intended to limit the technological features set forth herein to particular embodiments and the disclosure includes various changes, equivalents, or alternatives for the embodiments of the disclosure. With regard to the description of the drawings, similar reference numerals may be used to designate similar or relevant elements.

The expressions “a first”, “a second”, “the first”, “the second”, and the like as used in the disclosure may modify various elements regardless of the order and/or importance thereof, but does not limit the corresponding elements. These expressions may be used to distinguish between one element and any other element. For example, a first element may be named a second element, and similarly, a second element may be named a first element without departing from the scope of the disclosure.

In addition, the terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

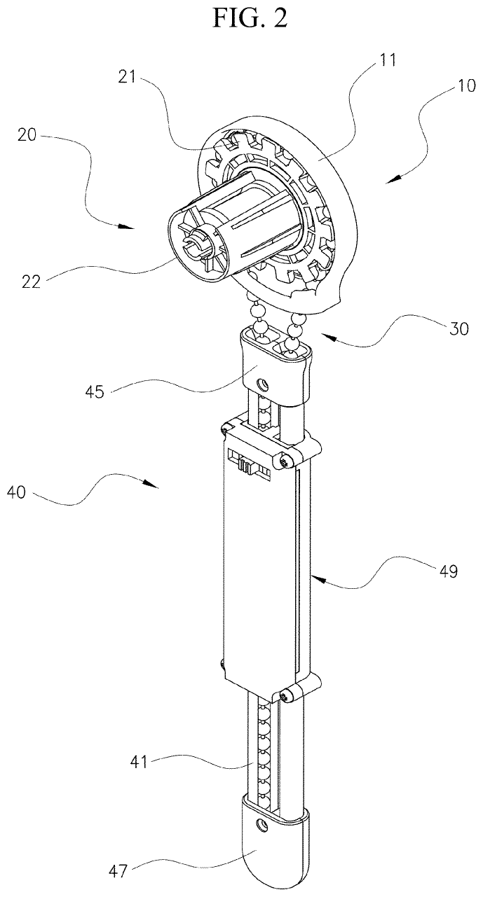

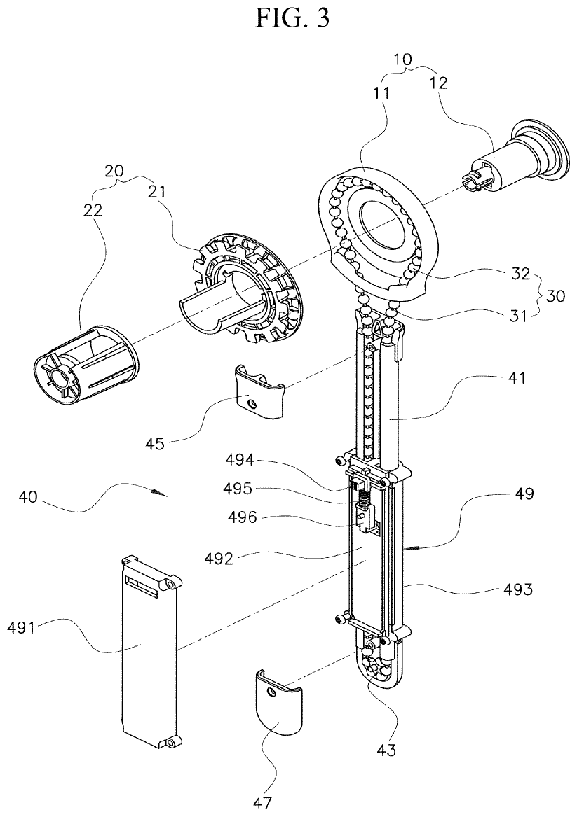

The present invention relates to a drive device for a roller blind, the drive device being configured to lower or raise a curtain fabric 1 by performing forward/reverse rotation of a drum 2 on which the curtain fabric 1 is wound, and includes a fixed part 10, a rotating part 20, a drive cord 30, and a manipulating part 40 as main components, as illustrated in FIGS. 2 and 3.

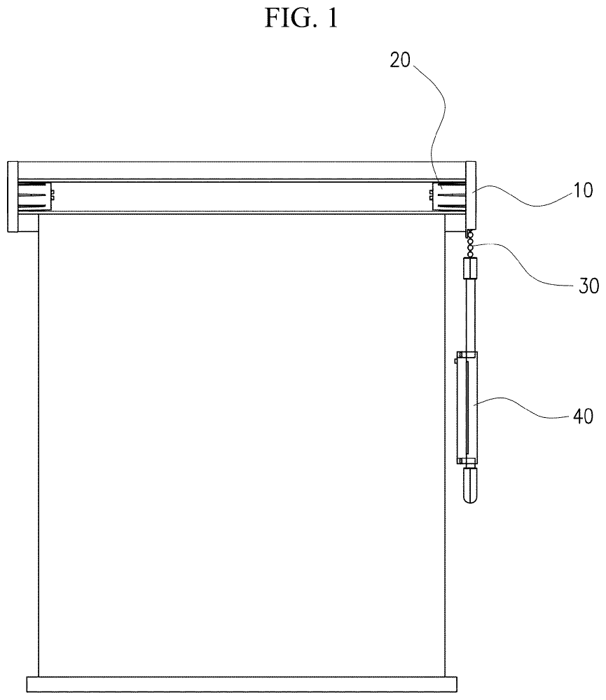

At this time, the forward rotation referred to in the present invention refers to the clockwise rotation of the drum 2 when the blind is viewed from the right side with reference to FIG. 1.

That is, when the drum 2 rotates in a clockwise direction, the curtain fabric 1 wound around the drum 2 unwinds and ascends, and when it rotates in a counterclockwise direction, the curtain fabric 1 is raised while being wound around the drum 2.

First, the fixed part 10 according to the present invention is fixedly disposed on the right or left side of the drum 2 as illustrated in FIG. 1 to rotatably support drum 2.

This fixed part 10 is composed of a fixed casing 11 and a fixed shaft 12, as illustrated in FIGS. 2 and 3.

The fixed casing 11 is formed into a disk shape having an inner diameter that can receive the rotating wheel 21, which will be described below.

The fixed shaft 12 is inserted into a center of the fixed casing 11 and rotatably supports the rotating wheel 21.

Here, the fixed casing 11 is formed such that a passage of a predetermined size is opened at a lower end so as to connect the drive cord 30 to the rotating part 20 and the manipulating part 40.

The rotating part 20 according to the present invention is rotatably mounted to the fixed part 10 as illustrated in FIG. 2, and rotates the drum 2 in forward/reverse direction such that the curtain fabric 1 is lowered or raised.

This rotating part 20 is composed of a rotating wheel 21 and a drum holder 22, as illustrated in FIG. 3.

The rotating wheel 21 is rotatably mounted at the inner center of the fixed casing 11, and a drive cord 30 is wound around the outer surface to receive the forward/reverse rotational force therefrom.

The drum holder 22 is mounted to the rotating wheel 21 by being engaging therewith, and is configured to be inserted into a center of one side of the drum 2 to perform the forward/reverse rotation of the drum 2.

The drive cord 30 according to the present invention is hung in parallel to the lower side of the fixed part 10 as illustrated in FIGS. 2 and 3, and transmits rotational force to the rotating part 20.

A conventional drive cord is formed by twisting a plurality of nylon threads. As such drive cords are used for a long period of time, they become worn which causes a phenomenon where fluff occurs to unwind.

Therefore, as illustrated in FIG. 3, in the present invention, the drive cord 30 is formed in a chain structure.

The drive cord 30 according to the present invention is formed by coupling spherical balls 33 with a cord 31 at predetermined intervals.

The spherical ball 33 is preferably formed of plastic, but is not limited as long as it is a durable material.

Since the spherical ball 33 is coupled to the cord 31, it is possible to prevent the cord 31 from loosening even when used for a long period of time, and protect against external force applied to the cord 31.

It goes without saying that the drive cord 30 according to the present invention can adopt other types of chain structures.

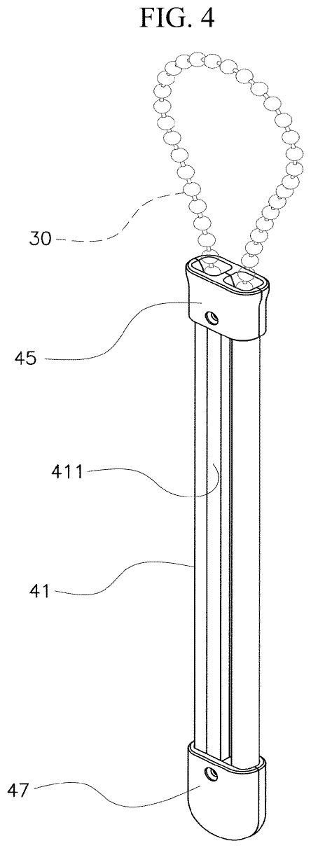

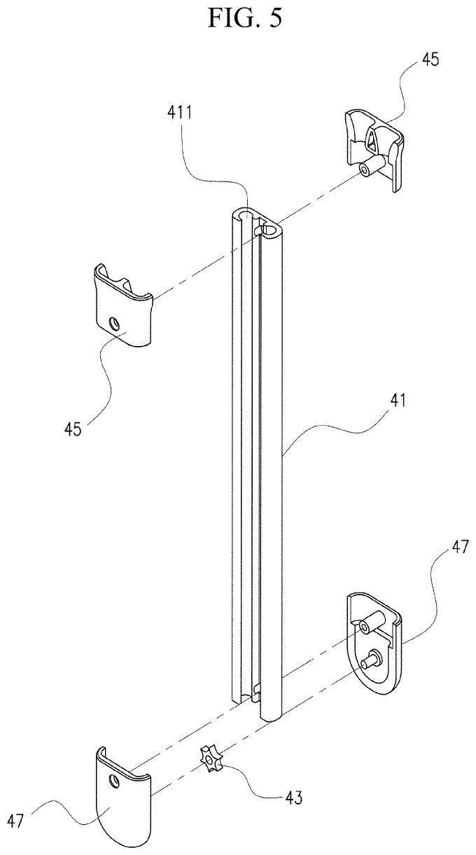

FIG. 4 is a perspective view of the drive cord and the manipulating part according to the present invention. FIG. 5 is an exploded view of the drive cord guide plate according to the present invention.

This will be explained with reference to FIGS. 4 and 5.

The manipulating part 40 of the present invention is coupled so as to cover the drive cord 30 hanging below the fixing unit 10.

In this manner, as the manipulating part 40 covers the drive cord 30, it is possible to prevent safety accidents that occur when a part of a person's body is wrapped around the drive cord 30.

The manipulating part 40 is configured to rotate the drive cord 30 in the forward or reverse direction in response to a pulling manipulation performed by a user, and includes a drive cord guide plate 41, a rotation gear 43, an upper cover 45, a lower cover 47, and a traction handle 49.

The drive cord guide plate 41 is configured such that a pair of guide grooves 411 with open ends are formed in the longitudinal direction.

The rotation gear 43 is rotatably coupled to one lower side of the drive cord guide plate 41.

The drive cord 30 is inserted into the guide groove 411 and travels, wherein the drive cord 30 meshes with the rotating gear 43, so that the direction of the drive cord 30 is changed.

The upper cover 45 is coupled so as to cover the upper part of the drive line guide plate 41 to prevent the drive cord 30 from being separated.

The lower cover 47 is coupled so as to cover the lower part of the drive cord guide plate 41 to prevent the drive cord 30 from being separated.

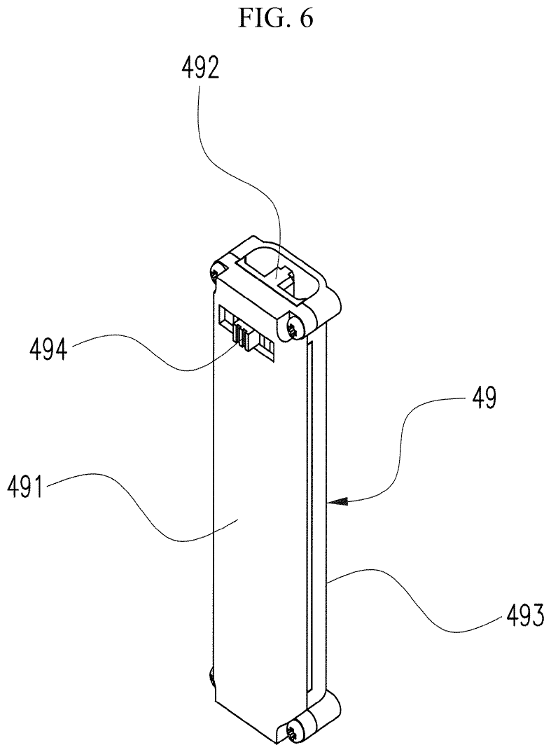

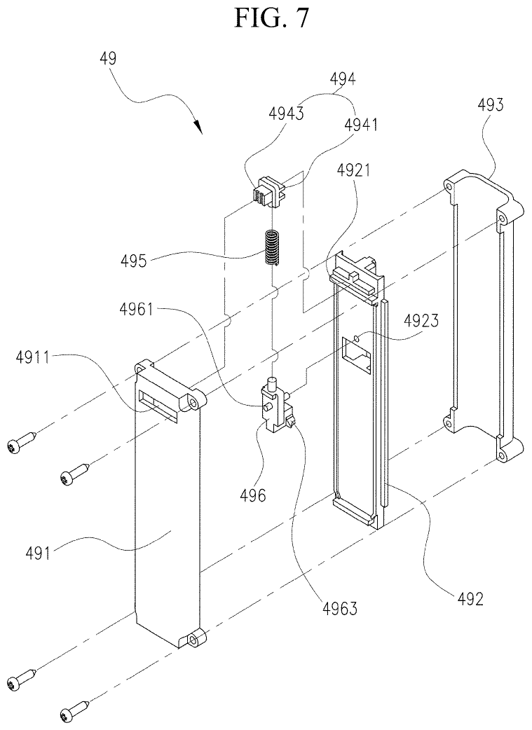

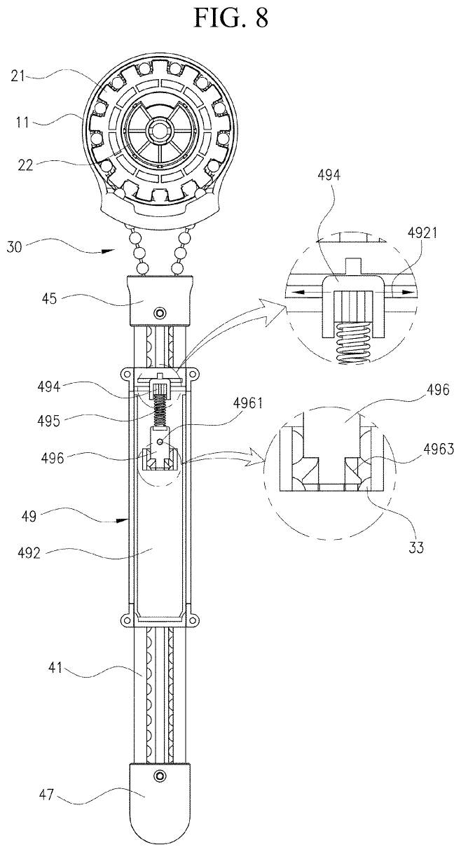

FIG. 6 is a perspective view of the traction handle according to the present invention. FIG. 7 is an exploded view of the traction handle according to the present invention. FIG. 8 is an enlarged view of the direction switch and the drive cord holding part according to the present invention.

This will be explained with reference to FIGS. 6 and 8.

The traction handle 49 is slidably coupled to the drive cord guide plate 41, and selectively presses any one of the two drive cords 30 arranged in parallel in an endless track to move the drive cord 30 in the forward or reverse direction.

The traction handle 49 includes a base plate 492, a direction switch 494, a drive cord holding part 496, a spring 495, and a front handle cover 491.

A switch guide 4921 and a hinge groove 4923 are formed on the base plate 492.

The switch guide 4921 is configured to guide the movement of the direction switch 494, and may be formed into a groove shape or a slot shape.

In FIG. 7, the switch guide 4921 is formed in a horizontal direction, but is not limited thereto. For example, it may be formed in an inclined manner.

The rotating pin 4961 of the drive cord holding part 496 is inserted into the hinge groove 4923.

The direction switch 494 is configured to select the direction in which the drive cord holding part 496 presses the drive cord 30.

The direction switch 494 is configured such that a guide protrusion 4941 coupled to the switch guide 4921 is formed at the rear, and an adjustment protrusion 4943 is formed in the front to adjust the direction switch 494.

The drive cord holding part 496 is configured to directly presses the drive cord 30, wherein a hinge pin 4961 is formed at the rear so as to rotate with respect to the base plate 492, and pointed edge-shaped holding protrusions 4963 for pressing the drive cord 30 are formed on both sides.

One end of the spring 495 is coupled to the direction switch 494, and the other end thereof is coupled to a portion higher than the rotating pin 4961 in the drive cord holding part 496.

The front handle cover 491 is coupled so as to cover the front surface of the base plate 492, and a direction switch opening 4911 is formed so as to expose the adjustment protrusion 4943.

Referring to FIG. 8, when the adjustment protrusion 4943 of the direction switch 494 moves to the left or right, the elastic force caused by the spring 495 rotates the drive cord looking body 496 around the rotating pin 4961, so that the holding protrusion 4963 moves in the opposite direction to the moving direction of the adjustment protrusion 4943 and presses the drive cord 30.

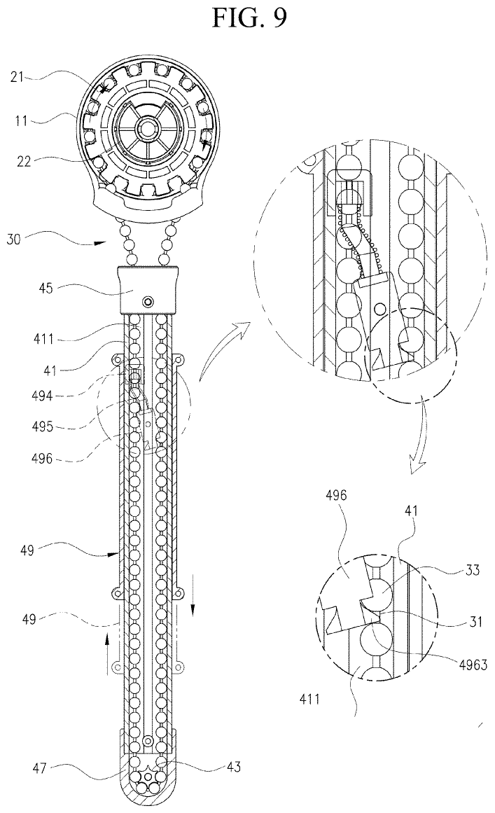

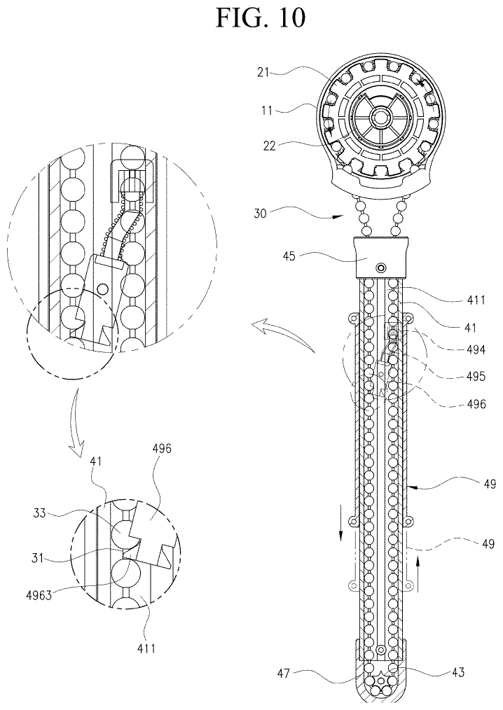

FIG. 9 is a diagram showing a state in which the drive cord holding part according to the present invention fixes the right drive cord. FIG. 10 is a diagram showing a state in which the drive cord holding part according to the present invention fixes the left drive cord.

This will be explained with reference to FIGS. 9 and 10.

In order to rotate the drive cord 30, the adjustment protrusion 4943 of the direction switch 494 is first moved to the left or right. Then, the drive cord looking body 496 presses one drive cord 30, and when the traction handle 49 is pulled down in this state, the pressed drive cord 30 descends.

When the traction handle 49 moves in the downward direction by the maximum stroke, the traction handle 49 is raised in the upward direction to further pull the drive cord 30.

When the traction handle 49 is raised in the upward direction, the holding protrusion 4963 that was pressing the drive cord 30 passes over the ball 33. At this time, the spring 495 supporting the holding protrusion 4963 is compressed, and when the holding protrusion 4963 presses the cord 31 between the balls 33 and the balls 33 again, the spring 495 stretches and presses the cord 31.

That is, when the traction handle 49 is raised, the drive cord 30 does not move and only the traction handle 49 moves upward.

The operation of lowering and raising the traction handle 49 in this way is repeated, so that the drive cord 30 can be lowered in one direction.

In the present invention, the rotation direction of the drive cord 30 can be intuitively grasped simply by checking the setting position of the direction switch 494. Further, when pulling the traction handle 49 to lower the pressed drive line 30, there is no need to apply force to the direction switch 494, thereby reducing the manipulating fatigue by the user.

The present invention relates to a blind drive device with a direction switch 494, and more particularly, to a blind drive device with a direction switch in which a manipulating part 40 is coupled so as to cover a drive cord 30, thereby preventing safety accidents caused by a drive cord 30 being wrapped around a user, while the user can intuitively grasp the rotation direction of the drive cord 30 just by the setting position of the direction switch 494, and further in which the user does not need to continuously press the direction switch 494 when pulling the drive cord 30, thereby reducing the manipulating fatigue by the user, and at the same time, the drive cord 30 is formed in a chain structure to ensure durability even when used for long periods of time.

Although the invention has been illustrated and described above with reference to preferred embodiments thereof, the scope of the present disclosure is not limited to specific embodiments described above, and numerous other modifications can be made by those skilled in the art, without departing from the spirit and scope of the principles of invention described in the appended claims. Further, these modifications should not understood individually from the technical spirit or perspective of the present disclosure.

1. A drive device for a roller blind, the drive device being configured to lower or raise a curtain fabric (1) by performing forward/reverse rotation of a drum (2) on which the curtain fabric (1) is wound, the drive device comprising:
a fixed part (10) that is fixedly disposed on a side of the drum (2);
a rotating part (20) that is rotatably mounted to the fixed part (10), and configured to perform the forward or reverse rotation of the drum (2) such that the curtain fabric (1) is lowered or raised;
two drive cords (30) that hangs in parallel to the rotating part (20) in the form of an endless loop on a lower side of the fixed part (10), and transmits a rotational force to the rotating part (20); and
a manipulating part (40) that is coupled so as to cover the drive cord (30) hanging on the lower side of the fixed part (10), and rotates the drive cord (30) in the forward or reverse direction according to pulling manipulation performed by a user.

2. The blind drive device according to claim 1, wherein the fixed part (10) comprises:
a fixed casing (11) that has an inner diameter capable of receiving the rotating part (20), and has a passage provided on a lower end thereof into a predetermined size such that the drive cord (30) is connected to the rotating part (20) and the manipulating part (40); and
a fixed shaft (12) that is inserted into and mounted to a center of the fixed casing (11) and rotatably supports the rotating part (20).

3. The blind drive device according to claim 2, wherein the rotating part (20) comprises:
a rotating wheel (21) that is rotatably mounted to the inside of the fixed case (11), and is connected to the drive cord (30) so as to receive forward/reverse direction rotational force therefrom; and
a drum holder (22) that is mounted to the rotating wheel (21) by being engaging therewith, and is configured to be inserted into a center of one side of the drum (2) to perform the forward/reverse rotation of the drum (2).

4. The blind drive device according to claim 1, wherein:
the drive cord (30) is formed in a chain structure.

5. The blind drive device according to claim 4, wherein:
the chain structure is a structure in which spherical balls (33) are coupled to a cord (31) at predetermined intervals.

6. The blind drive device according to claim 1, wherein the manipulating part (40) comprises:
a drive cord guide plate (41) in which a pair of guide grooves (411) opened at both ends are formed in a longitudinal direction; and
a rotating gear (43) that is rotatably coupled to one side of the lower part of the drive cord guide plate (41),
wherein the drive cord (30) is inserted into the guide groove (411) and travels, and
wherein the drive cord (30) meshes with the rotating gear (43) to change the direction of the drive cord (30).

7. The blind drive device according to claim 6, further comprising:
an upper cover (45) that is coupled so as to cover the upper part of the drive cord guide plate (41) to prevents separation of the drive cord (30); and
a lower cover (47) that prevents separation of the drive cord (30).

8. The blind drive device according to claim 6, wherein the manipulating part (40) comprises:
a traction handle (49) that is slidably coupled to the drive cord guide plate (41), and rotates the drive cord (30) in the forward or reverse direction by selectively pressing any one of the two drive cords (30) arranged in parallel in the form of an endless track.

9. The blind drive device according to claim 8, wherein the traction handle (49) comprises:
a base plate (492) provided with a switch guide (4921) formed into a groove shape or a protruding slot shape to guide the movement of the direction switch (494), and a hinge groove (4923) into which a rotating pin (4961) of a drive cord holding part (496) is inserted;
a direction switch (494) in which a guide protrusion (4941) coupled to the switch guide (4921) is formed at the rear, and an adjustment protrusion (4943) that adjusts the direction switch (494) is formed at the front;
a drive cord holding part (496) in which a hinge pin (4961) is formed at the rear so as to be rotatable relative to the base plate (492), and a pointed edge-shaped holding protrusion (4963) for pressing the drive cord (30) are formed on both sides surface;
a spring (495) in which one end is coupled to the direction switch (494), and the other end is coupled to a portion higher than the rotating pin (4961) in the drive cord holding part (496); and
a front handle cover 491 that is coupled to cover the front of the base plate (492), and a direction switch opening (4911) is formed to expose the adjustment protrusion (4943),
wherein when the adjustment protrusion (4943) moves to the left or right, the elastic force caused by the spring (495) rotates the drive cord holding part (496) around the rotating pin (4961), and moves in a direction opposite to the moving direction of the adjustment protrusion (4943) and presses the drive cord (30).
